(19) United States
(12) Patent Application Publication
(10) Pub. No.: US 2009/0294319 A1
(43) Pub. Date: Dec. 3, 2009

(54) Blister base part and blister pack

(76) Inventors: Hans R. Nägeli, Neuhausen (CH); Franz P. Hombach, Beringen (CH); Erwin Pasbrig, Singen (DE); Oliver Brandl, Konstanz (DE); Thomas Schwarz, Gottmadingen (DE)

Correspondence Address: FISHER, CHRISTEN & SABOL, 1120 20TH STREET, NW, SOUTH TOWER, SUITE 750, WASHINGTON, DC, 20036, US

(21) Appl. No.: 11/921,071

(22) PCT Filed: Jun. 13, 2006
(86) PCT No.: PCT/EP2006/005635

§ 371 Date: Nov. 27, 2007

(30) Foreign Application Priority Data
Jun. 15, 2005 (EP) EP05405383

(51) Int. Cl. B65D 75/36; B32B 3/30; B65D 81/26

(52) U.S. Cl. 206/461; 428/161; 206/524.4

(57) ABSTRACT

A blister base part made of a laminate with wells formed from the latter by cold-forming for the production of a blister pack for the packaging of products that are sensitive to moisture, oxygen and acid has a barrier layer as a barrier against water vapor and gases, a plastics material layer arranged on a first side of the barrier layer as the outer layer and a sealable inner layer arranged on the second side of the barrier layer, and to increase the durability, an absorber material absorbing moisture, oxygen and acid is arranged on the second side of the barrier layer.

The invention relates to a blister base part made of a laminate with wells formed from the latter by cold-forming for the production of a blister pack for the packaging of products that are sensitive to moisture, oxygen and acid, comprising a barrier layer as a barrier against water vapour and gases, a plastics material layer arranged on a first side of the barrier layer as the outer layer and a sealable inner layer arranged on the second side of the barrier layer. The invention also relates to a blister pack with a blister base part of an outer foil sealed against the inner layer of the laminate against the inside of the blister base part and comprising a barrier layer as a barrier against water vapour and gases and a sealable inner layer arranged on a first side of the barrier layer.

It is generally known to protect products which are sensitive to moisture and oxygen from damaging atmospheric influences by packaging them in plastics materials. Moisture-sensitive products may be enveloped, for example, with a plastics material film which is practically impermeable to water molecules. A film made of a high-density polyethylene (HDPE) or of a polyvinylidenechloride methylacrylate copolymer (PVDC-MA) can be used, for example, as a barrier against the penetration of moisture. Films made of oriented polypropylene (oPP), optionally metallised, or metallised polyester films, are also used as barrier material against the penetration of moisture. Furthermore, metal foils are known as a barrier material against the penetration of moisture and/or oxygen and are often used in combination with plastics material films. A good barrier effect against water vapour and gases can also be achieved with a layer made of ethylene vinylalcohol copolymer (EVOH).

Although laminates with barrier layers with a high penetration barrier effect against moisture and oxygen are known nowadays, the penetration of moisture cannot be completely prevented particularly in sealed packagings as the edges of the laminates are not protected by the barrier layer. Moisture and oxygen can penetrate into the inner hot-sealed packagings by way of these unprotected edges in the region of seals and impair the quality of moisture-sensitive products.

Multi-layer films with a barrier layer and with a sealing layer containing moisture-absorbing material are known from WO-A-2004/000541 and WO-A-2004/080808. The films are used for packaging moisture-sensitive articles, such as, for example, test strips for diagnostics, and are either hot sealed, after folding, against themselves or against a second film. Calcium oxide (CaO) is preferably used as the moisture-absorbing material with strong binding of water.

The invention is based on the object of providing a blister base part which is suitable for producing blister packs for packaging products which are sensitive to moisture, oxygen and acid, as well as blister packs of the type mentioned at the outset, which have a higher protective effect against the penetration of moisture, oxygen and acid compared to blister base parts or blister packs according to the prior art.

The fact that an absorber material, which absorbs moisture, oxygen and acid, is arranged on the second side of the barrier layer leads to the achievement of the object according to the invention with regard to the blister base part.

The laminate which is used according to the invention can be used on all packaging systems with cold-forming stations and is suitable for a large number of moisture-sensitive products, the durability of which can be substantially increased by the special arrangement of a moisture absorber.

The invention makes use of the knowledge obtained regarding packaging films and packagings produced therefrom according to WO-A-2004/000541 and WO-A-2004/080808.

The inner layer preferably consists of polyolefin and preferably contains at least one oxide from the group of alkali metals and alkaline earth metals as the absorber material. Calcium oxide (CaO) is particularly preferred as the absorber material. Apart from its property as a water-binding reagent, CaO offers the additional advantage that acid formers, such as, for example chlorine ions or organic acids, which are separated from the products, react as gases or as acid formed by reaction with water with the CaO to form salt and are thus bound. In addition, it has been shown that CaO is also able to absorb oxygen, in other words has the properties of an oxygen scavenger.

The preferred content of the polyolefin of the inner layer is 0.5 to 50% by weight CaO, in particular 10 to 30% by weight CaO.

The polyolefin of the inner layer preferably consists of a high-density polyethylene (HDPE) and/or a linear low-density polyethylene (LLDPE) and/or a low-density polyethylene (LDPE) and/or of polypropylene (PP). Components of acid-modified polyolefins, such as ionomers, for example Surlyn®, EAA or PP-MSA may also be contained. These acid modified polyolefins act as adhesion promoters, so in certain cases a separate primer can be dispensed with.

The polyolefin of the inner layer may consist of a single layer or of a plurality of layers.

A base part made of a laminate is particularly preferred, in which the polyolefin of the inner layer consists of at least two layers, the outermost layer which is furthest removed from the aluminium foil containing substantially no absorber material. With this measure, a smooth surface is produced, so the coefficient of friction of the laminate according to the invention corresponds to conventional laminates. Because additives such as CaO are missing in the outermost layer, in comparison to conventional laminates, there is no abrasion either during processing on moulding dies or other machine components.

As absorption agents such as CaO react alkalinically with the moisture, the additive-free outermost layer also prevents a change in the pH being able to negatively influence the filling with regard to stability.

A base part made of a laminate, in which the polyolefin of the inner layer is a coextrusion layer made of at least two layers is particularly preferred, the outermost layer which is furthest removed from the aluminium foil containing substantially no absorber material.

In the laminate of the base part according to the invention, the barrier layer is preferably an aluminium foil and preferably coated on the side facing the polyolefin with an adhesion promoter, in particular with a water-based or solvent-based primer, or with a polymeric adhesion promoter.

The innermost layer which is located closest to the barrier layer preferably contains substantially no absorber material. Thus, the particles of the absorber material cannot press into the aluminium foil which is used as the barrier layer during the cold-forming step carried out under pressure. With this measure, the particles cannot produce any potential weak points in the aluminium foil and therefore not reduce the pore-free deformability either.

The outer layer is preferably a plastics material film which is connected to the aluminium foil by way of an adhesive layer and made of oriented polyamide (oPA), oriented polypropylene (oPP) or oriented polyester.

An outer foil sealed against the inside of the blister base part and having a barrier layer as a barrier against water vapour and gases and a sealable inner layer arranged on the first side of the barrier layer leads to the achievement of the object according to the invention with regard to the blister pack.

The polyolefin of the inner layer preferably consists of a high-density polyethylene (HDPE) and/or a linear low-density polyethylene (LLDPE) and/or a low-density polyethylene (LDPE) and/or of polypropylene (PP) and/or contains components of acid-modified polyolefins, such as ionomers, EAA or PP MSA.

The polyolefin of the inner layer preferably consists of a single layer. The sealable inner layer comprises a sealing medium in the form of a lacquer, in particular a hot sealing lacquer, a foil or a sealable coating and is used for sealing the outer foil against the inside of the blister base part, it being possible for the seal to be a rigid seal or a seal with low adhesive force to form a peelable opening.

The barrier layer is preferably an aluminium foil.

To produce a blister pack for packaging products which are sensitive to moisture, oxygen and acid, a blister base part is firstly manufactured from the laminate according to the invention by cold-forming. After filling the blister base part, an outer foil, which comprises a barrier layer as a barrier against water vapour and gases, is then sealed against the inner layer of the laminate on the blister base part.

The blister pack according to the invention is preferably used for packaging pharmaceutical products such as moisture-sensitive tablets and powders.

Further advantages, features and details of the invention emerge from the following description of preferred embodiments and with the aid of the drawings, in which, schematically

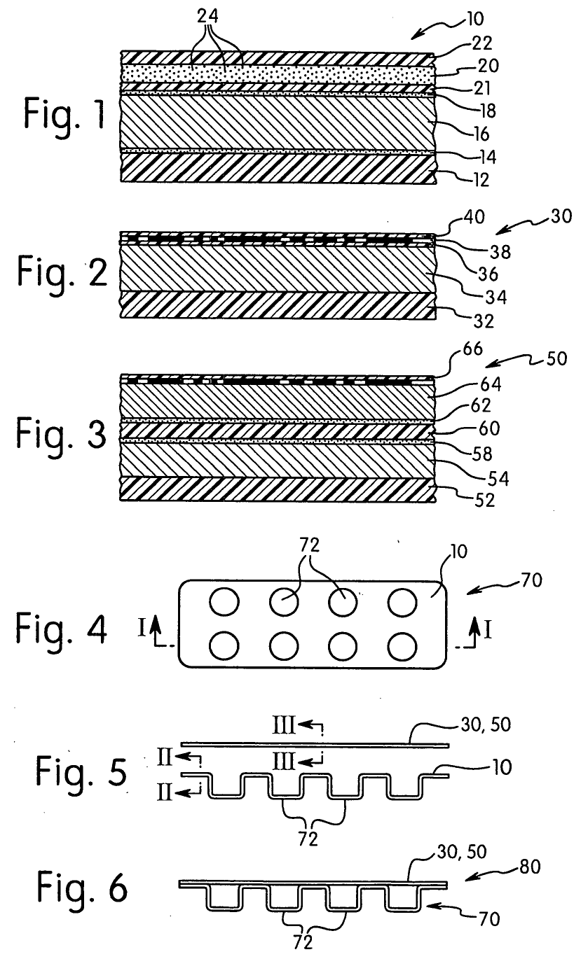

FIG. 1 shows the layer structure of a cold-formable laminate for the production of blister base parts according to FIG. 5, along the section line II-II of FIG. 5;

FIG. 2 shows the layer structure of a push-through outer foil for blister base parts according to FIG. 5, along the section line III-III of FIG. 5;

FIG. 3 shows the layer structure of a peelable outer foil for blister base parts;

FIG. 4 shows the plan view of a cold-formed blister base part made of the laminate of FIG. 1;

FIG. 5 shows the section through the blister base part of FIG. 5 along its line I-I;

FIG. 6 shows the blister base part of FIG. 5 with the sealed-on push-through foil of FIG. 2 or a peelable outer foil of FIG. 3.

A cold-formable laminate 10 for the production of blister base parts for the packaging of moisture-sensitive products has, according to FIG. 1, the following layer structure:

| | |
|---|---|
| 12 | film made of oriented polyamide (oPA), 25 μm |
| 14 | adhesive layer |
| 16 | aluminium foil, 45 μm |
| 18 | adhesion promoter (EAA), |
| 21 | first layer made of high-density polyethylene (HDPE), 7 μm |
| 20 | second layer made of polyethylene (PE), 45 μm, with |
| 24 | 30% CaO particles as absorbers of moisture, oxygen and acid |
| 22 | third layer of high-density polyethylene (HDPE), 7 μm. |

The oPA film 12 forms the future outside of a blister produced from the laminate 10; the PE layers 20, 21, 22 form the inside as the sealing layer.

An outer foil 30 which is configured as a push-through foil for a blister produced from the laminate 10 has, according to FIG. 21, the following layer structure:

| | |
|---|---|
| 32 | hot-sealing lacquer or sealing coating |
| 34 | aluminium foil |
| 36 | print undercoat lacquer |
| 38 | printing |
| 40 | print overcoat lacquer |

The printing 38 with the print overcoat lacquer forms the future outside of the outer foil 30 and the hot-sealing lacquer or the sealing coating 32 is used to seal the outer foil 30 against the sealing layer 22 of a blister base part produced from the laminate 10.

An outer foil 50 configured as a peelable foil, for a blister base part produced from the laminate 10, according to FIG. 3, has the following layer structure:

| | |
|---|---|
| 52 | hot-sealing lacquer or sealing coating |
| 54 | aluminium foil |
| 56 | adhesive layer |
| 58 | film made of polyethylene terephthalate (PET) |
| 60 | adhesive layer |
| 62 | paper |
| 64 | printing |
| 66 | print overcoat lacquer |

The printing 64 with the print overcoat lacquer 66 forms the future outside of the peelable outer foil 50 and the hot-sealing lacquer or the sealing coating 52 is used to seal the outer foil 50 against the PE layer 22 of a blister base part produced from the laminate 10.

A blister base part 70 shown in FIG. 4 is produced from the laminate 10, the wells 72 formed from the laminate 10 to receive, for example, tablets, being formed from the laminate 10 by cold-forming such as, for example, by deep drawing by means of an upper and bottom die.

As shown in FIG. 5 and 6, after filling the wells 72, as required, a push-through outer foil 30 or a peelable outer foil 50 are sealed onto the blister base part 70, as required, to form a blister pack 80.

1. A blister base part (70) made of a laminate (10) with wells (72) formed from the latter by cold-forming for the production of a blister pack (70) for the packaging of products that are sensitive to moisture, oxygen and acid, there is a barrier layer (16) as a barrier against water vapor and gases, a plastics material layer (12) is arranged on a first side of the barrier layer (16) as the outer layer and a sealable inner layer (20, 21, 22) is arranged on the second side of the barrier layer (16), an absorber material (24) which absorbs moisture, oxygen and acid is arranged on the second side of the barrier layer (16).

2. The blister base part (70) according to claim 1, wherein the inner layer (20) contains polyolefin with at least one oxide from the group of alkali metals and alkaline earth metals as the absorber material (24).

3. The blister base part (70) according to claim 2, wherein the polyolefin of the inner layer (20) contains calcium oxide (CaO) as the absorber material (24).

4. The blister base part (70) according to claim 3, wherein the polyolefin of the inner layer (20) contains 0.5 to 50% percent by weight CaO, preferably 10 to 30% by weight Cao, as the absorber material (24).

5. The blister base part (70) according to claim 1, wherein the polyolefin of the inner layer (20) consists of polyethylene (PE), in particular of a high-density polyethylene (HDPE) and/or a low-density linear polyethylene (LLDPE) and/or a low-density polyethylene (LDPE) and/or of polypropylene (PP) and/or contains components of acid-modified polyolefins, such as ionomers, EAA or PP-MSA.

6. The blister base part (70) according to claim 1, wherein the polyolefin of the inner layer (20, 22) consists of a single layer.

7. The blister base part (70) according to claim 1, wherein the polyolefin of the inner layer consists of a plurality of layers (20, 21, 22).

8. The blister base part (70) according to claim 7, wherein the polyolefin of the inner layer consists of at least two layers (20, 22) the outermost layer (22) which is furthest removed from the barrier layer (16) containing substantially no absorber material (24).

9. The blister base part (70) according to claim 8, wherein the polyolefin of the inner layer is a coextrusion layer made of at least two layers (20, 22).

10. The blister base part (70) according to claim 18, wherein the innermost layer (21) which is located closest to the barrier layer (16) contains substantially no absorber material (24).

11. The blister base part (70) according to claim 1, wherein the barrier layer (16) is an aluminum foil and is coated on the side facing the polyolefin with an adhesion promoter (18), in particular with a water-based or solvent-based primer or with a polymeric adhesion promoter.

12. The blister base part (70) according to claim 11, wherein the outer layer (12) is a plastics material (12) which is connected to the aluminum foil (16) by way of an adhesive layer (14) and made of oriented polyamide, oriented polypropylene or oriented polyester.

13. The blister pack (80) for packaging products which are sensitive to moisture, oxygen and acid, comprising a blister base part (70) according to claim 1 and an outer foil (30, 50) sealed against the inside of the blister base part (70) comprising a barrier layer (34, 54) as a barrier against water vapour vapor and gases and a sealable inner layer (32, 52) arranged on a first side of the barrier layer (34, 54).

14. A process of utilizing a blister pack (80) according to claim 13 for packaging pharmaceutical products, such as moisture-sensitive tablets and powders.

15. The blister base part (70) according to claim 4, wherein the polyolefin of the inner layer (20) consists of polyethylene (PE), in particular of a high-density polyethylene (HDPE) and/or a low-density linear polyethylene (LLDPE) and/or a low-density polyethylene (LDPE) and/or of polypropylene (PP) and/or contains components of acid-modified polyolefins, such as ionomers, EAA or PP-MSA.

16. The blister base part (70) according to claim 15, wherein the polyolefin of the inner layer (20, 22) consists of a single layer.

17. The blister base part (70) according to claim 15, wherein the polyolefin of the inner layer consists of a plurality of layers (20, 21, 22).

18. The blister base part (70) according to claim 17, wherein the polyolefin of the inner layer consists of at least two layers (20, 22) the outermost layer (22) which is furthest removed from the barrier layer (16) containing substantially no absorber material (24).

19. The blister base part (70) according to claim 18, wherein the polyolefin of the inner layer is a coextrusion layer made of at least two layers (20, 22).

20. The blister base part (70) according to claim 19, wherein the innermost layer (21) which is located closest to the barrier layer (16) contains substantially no absorber material (24).

21. The blister base part (70) according to claim 20, wherein the barrier layer (16) is an aluminum foil and is coated on the side facing the polyolefin with an adhesion promoter (18), in particular with a water-based or solvent-based primer or with a polymeric adhesion promoter.

22. The blister base part (70) according to claim 16, wherein the barrier layer (16) is an aluminum foil and is coated on the side facing the polyolefin with an adhesion promoter (18), in particular with a water-based or solvent-based primer or with a polymeric adhesion promoter.

23. The blister base part (70) according to claim 21, wherein the outer layer (12) is a plastics material (12) which is connected to the aluminum foil (16) by way of an adhesive layer (14) and made of oriented polyamide, oriented polypropylene or oriented polyester.

24. The blister base part (70) according to claim 22, wherein the outer layer (12) is a plastics material (12) which is connected to the aluminum foil (16) by way of an adhesive layer (14) and made of oriented polyamide, oriented polypropylene or oriented polyester.

25. The blister pack (80) for packaging products which are sensitive to moisture, oxygen and acid, comprising a blister base part (70) according to claim 23 and an outer foil (30, 50) sealed against the inside of the blister base part (70) comprising a barrier layer (34, 54) as a barrier against water vapor and gases and a sealable inner layer (32, 52) arranged on a first side of the barrier layer (34, 54).

26. The blister pack (80) for packaging products which are sensitive to moisture, oxygen and acid, comprising a blister base part (70) according to claim 24 and an outer foil (30, 50) sealed against the inside of the blister base part (70) comprising a barrier layer (34, 54) as a barrier against water vapor and gases and a sealable inner layer (32, 52) arranged on a first side of the barrier layer (34, 54).

27. A process of utilizing a blister pack (80) according to claim 25 for packaging pharmaceutical products, such as moisture-sensitive tablets and powders.

28. A process of utilizing a blister pack (80) according to claim 26 for packaging pharmaceutical products, such as moisture-sensitive tablets and powders.

29. The blister base part (70) according to claim 4, wherein the polyolefin of the inner layer (20) contains 10 to 30 percent by weight CaO.
